(19) United States
(12) Patent Application Publication
(10) Pub. No.: US 2006/0294210 A1
(43) Pub. Date: Dec. 28, 2006

(54) Ad-hoc multimedia information exploitation via web services and mobile agents

(76) Inventor: Benjamin W. Falchuk, Upper Nyack, NY (US)

Correspondence Address: TELCORDIA TECHNOLOGIES, INC., ONE TELCORDIA DRIVE 5G116, PISCATAWAY, NJ, 08854-4157, US

(21) Appl. No.: 11/167,029

(22) Filed: Jun. 27, 2005

(51) Int. Cl. G06F 15/177

(52) U.S. Cl. 709/220

(57) ABSTRACT

A method and system for transient access to multimedia data using devices attached to a communications network enables Web Services to be deployed in an ad-hoc fashion on networked devices using taskable mobile agents. Transient Web Services are transported and remotely controlled by mobile agents, thereby enabling information exploitation.

### FIELD OF THE INVENTION

The present invention concerns a method and system for transient access to multimedia data using devices attached to a communications network. Specifically, the method and system enable Web Services to be deployed in an ad-hoc fashion on networked computing devices using taskable mobile agents. The invention is applicable in distributed systems such as enterprises and Internet.

### BACKGROUND OF THE INVENTION

In typical distributed systems it is not unusual to find Web Services (or more generally, Service Oriented Architectures) supporting information exchange, transactions, and tasking. Similarly, it is not unusual in domains such as manufacturing, aerospace, and military, to find an infrastructure for software agents allowing flexible, scalable, autonomous computing and tasking. A service is an application whose main service control logic is via its user-modifiable data. Service data is the data behind the service. The present invention concerns a framework which begins to enable the best characteristics of both of the above scenarios in which a Web Service that is designed such that calls to its operations allow the exploitation of the device service data is transported to, and deployed upon, a remote device. The Web Service implementation arrives at the device encapsulated within a mobile agent (sent by a controller user); upon arrival the mobile agent ‘deploys’ the software required to realize the Web Service's deployment. Once deployed, the Web Service acts as a facade to the node's stored multimedia data (e.g. documents, images, and songs) allowing other clients to exploit the data, either transparently or quite visibly to the node's user. Exploitation of the multimedia data can be anything from mining business intelligence, to image sharing, to alerting and entertainment. At a later time the ad-hoc service is torn down from the device or terminates. Ad-hoc service is a software entity that implements a gateway pattern, encapsulating transient access to service data.

There are many realistic scenarios in present day distributed multimedia systems which can advantageously use what is hereinafter sometimes referred to as Ad-Hoc Services (AHS); that is, those services that are lightweight, agile, and provide transient but important access to stored information via well-established Web Service protocols, such as the Simple Object Access Protocol (SOAP). SOAP is described, for example, at W3C Web Services, http://www.w3.org/2002/ws/ which is incorporated herein by reference. Ad hoc services transiently inhabit corporate desktops and mobile devices such as cellular phones; all the while, their lifecycles are mostly transparent to the owner of the device on which they operate. Ad hoc services are desirable when: there is no central server indexing distributed multimedia contents of remote devices; there is some competitive advantage that can be gained from remote data exploitation; or a “thin” transparent approach is desirable.

In peer-to-peer file-sharing, file-sharers make up what is sometimes called the transient Web. Unlike permanent Web nodes, transient Web nodes come and go in unpredictable fashion with variable network addresses. In the mobile agents realm, a special-purpose software infrastructure in combination with a communications protocol allow autonomous software entities (each with some goal, a plan, and policies admitting interaction) to migrate from node to node while coordinating with other resources to achieve a goal.

A Web service is, a software system designed to support interoperable machine-to-machine interaction over a network. For clients, a Web Service's interface is described in a machine-processable format and for access the client uses the Simple Object Access Protocol messages (usually over HTTP). In the networking universe, ad-hoc networks are autonomous networks that do not rely on fixed infrastructure. Within the network each node serves as a router and forwards packets for other nodes; the topology continuously changes.

The AHS approach, in which transient Web Services are transported and remotely controlled by mobile agents, enables powerful and feasible new information exploitation opportunities.

In the AHS approach there are benefits usually associated with the mobile agents and Web Services approaches. That is, by deploying Web Service logic to remote machines via autonomous mobile agents the result is the flexibility and taskability usually seen in agents deployments (military, industry, etc). By conforming to SOAP and Web Services specifications, for example, there are access mechanisms that are easily and universally exploited.

### SUMMARY OF THE INVENTION

In accordance with the teachings of the present invention, referred to as the AHS approach, transient Web Services are transported and remotely controlled by mobile agents, thereby enabling powerful new information exploitation opportunities. For example, PC and cellular phone operating systems are now capable of running (small-footprint) agent-environments and Web Servers. Furthermore, most of these computing devices contain several built-in multimedia applications such as calendars, instant messaging (IM) and cameras. Ad hoc services, therefore, have a rich field of untapped multimedia service data.

AHS has followed from experience with Agent-based NGN (next-generation-network) Services integration. The principal design requirements for AHS include: (1) facilitate information exploitation by making more systematic (and transparent) the process of mining information from user devices; (2) serve as a multimedia data exploitation tool in deployments where no central server indexes device multimedia data; (3) exploit off-the shelf and standard software and protocols such as Web Services (e.g. SOAP) and agent software and standards (e.g. JADE or FIPA); and (4) lightweight software components, in terms of memory footprint and complexity.

To the extent that AHS operation requires some pre-loading and setup of software on networked devices, devices can be programmed such that the setup occurs automatically upon device ‘startup’, as a system service, and the like. Thus, the setup phase can be transparent and unintrusive to the device owner and/or user.

Three typical AHS uses envisioned in the present invention which help to illustrate the benefits of the framework are as follows:

Lightweight Corporate Information Mining. AHS service is deployed to, and activated via agents on, networked devices of employees, exposing Calendar, Inbox, and Notes service data to authorized clients. The AHS services on employees' devices are later torn-down. The whole process is transparent to, but allowed by, the employee.

Mobile Device Applications and Mining. An AHS service is deployed to a Java-enabled smart phone or wireless PDA and with permission exposes shared contacts, phone numbers, recent calls or other potentially useful information. A service consumer manipulates a subset of this information and subjects it to exploitation algorithms.

Overriding Desktop Application (Calendar) Semantics. Powerful use-cases in which an AHS service is deployed to a user's desktop and allows the remote backup of the device current calendar data. Once backed up, the calendar screen can be temporarily exploited for any other purpose; for example, the ‘week’ view can be used as an output screen.

It will be understood that the invention is not limited to solely these uses which are presented merely as illustrative examples.

A principal object of the present invention is therefore, the provision of a method and system for transient access to multimedia data using devices attached to a communications network enabling Web Services to be deployed in an ad-hoc fashion on networked devices using taskable mobile agents.

Another object of the present invention is the provision of a method and system where transient Web Services are transported and remotely controlled by mobile agents for enabling information exploitation.

Further and still other objects of the present invention will become more clearly apparent when the following description is read in conjunction with the accompanying drawings.

### BRIEF DESCRIPTION OF THE DRAWINGS

FIGS. 1A, 1B and 1C illustrate conceptually ad-hoc services in its pre-AHS phase, deployment phase and exploitation phase, respectively.

FIG. 2 is a schematic representation of an ad-hoc services architecture.

FIG. 3 is a schematic representation of as-hoc services access.

FIG. 4 shows a controller spawning two mobile agents, where each agent migrates to a device and allows temporary SOAP-based access to the device's Microsoft Outlook® service data.

FIG. 5. shows the effects of an ad-hoc service taking temporary control of a user's Calendar, clearing the calendar, and then using the week-view as a banner page (the letter ‘M’).

### DETAILED DESCRIPTION

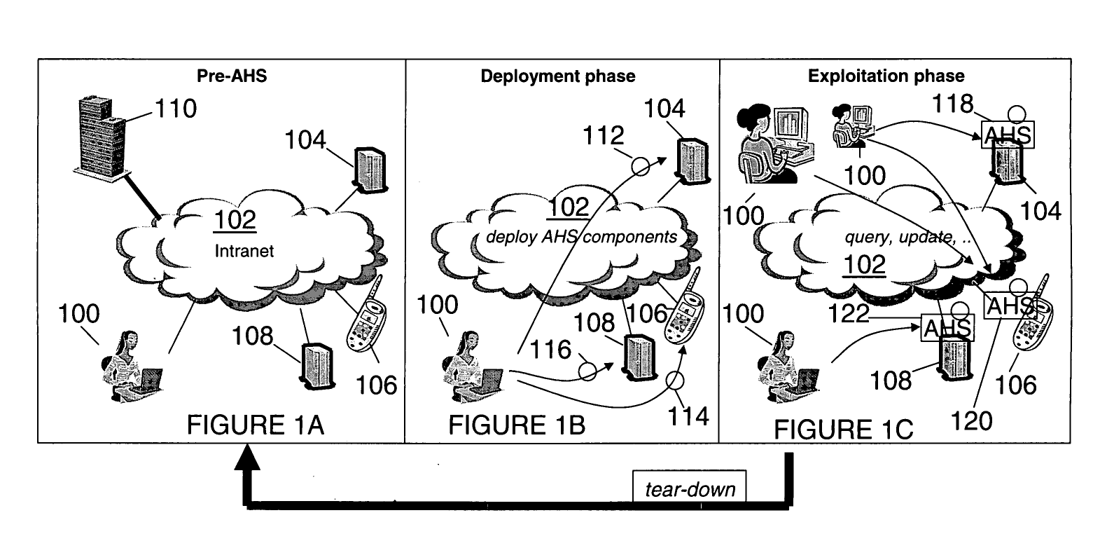

Referring now to the figures and to FIGS. 1A, 1B and 1C in particular, there are shown an illustration of the AHS paradigm. Two advantages of AHS are: agility, which refers to being easy to run and cross-platform compatible, and lightweight, which refers to a small memory footprint and not CPU-intensive. The AHS architecture supports the following main stages of ad hoc services:

Service creation, i.e., the service that façades a device-resident multimedia service.

Deploying the service to a remote device.

Controlling the service lifecycle.

Providing access to the service, including controlling security and privacy. ‘Ad hoc’ does not imply that security will not be enforced.

Subsequent exploitation of the device data.

Service creation shown in FIG. 1A is the stage at which the AHS developer or administrator 100 develops both the API and implementation of the service. An intranet or network 102 connects data containing devices such as a computer 104, cellular phone 106, and the like, to a controller 108 and an enterprise 110. For example, if an AHS service called ‘Microsoft Office Miner’ is to provide SOAP-based access to Microsoft Office multimedia Service Data on a remote device, such as computer 104 or cellular phone 106, then the developer writes the implementation logic in Java, gathering all required Java lightweight libraries. This implementation might exploit technologies such as IBM's InterfaceTool which enables Java to COM communications (such as Outlook, Internet Explorer, etc.). While the invention may be described in conjunction with Microsoft Office Miner and a Web Services SOAP server, it will be understood that the invention is not so limited to a particular server or service.

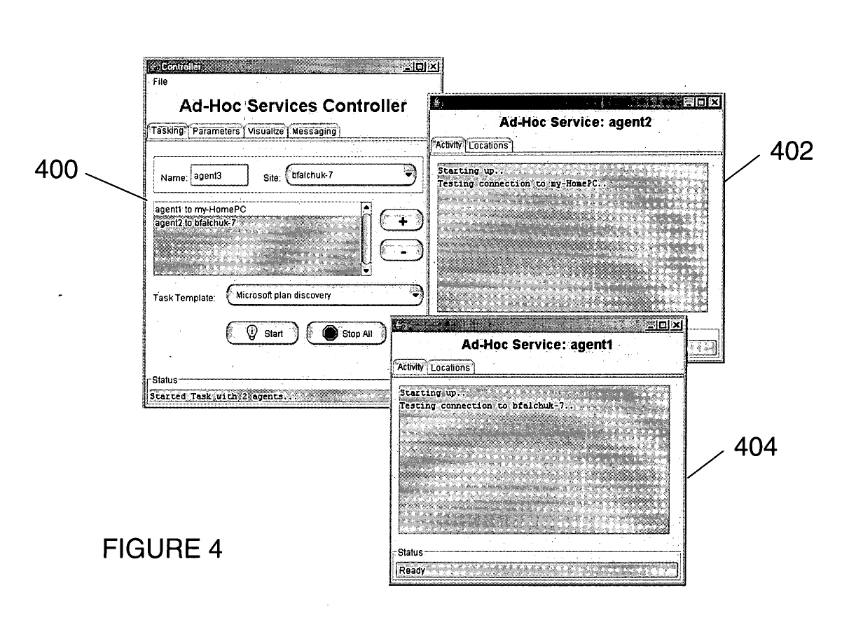

Service deployment shown in FIG. 1B is the process by which a mobile agent transports respective mobile agents 112, 114, 116 and Web Services implementation logic via network 102. In the present example, the Microsoft Office Miner implementation, along with a Web Services SOAP server and all supporting libraries are transported to the device/PC 104 on which it is to run. In a particular embodiment, the devices are in a TCP/IP network running a mobile agent server such as a JADE server (which can be setup to run as a system service). Developers do not need to write a new mobile agent for each task. Instead, administrators may use the AHS Controller GUI 400 in FIG. 4 to specify parameters.

In the exploitation phase shown in FIG. 1C, one or more developers 100 make queries or provide updates via network 102 or AHS framework 118, 120, 122 to the various data containing devices 104, 106 and controller 108, all of which use Web Services protocols.

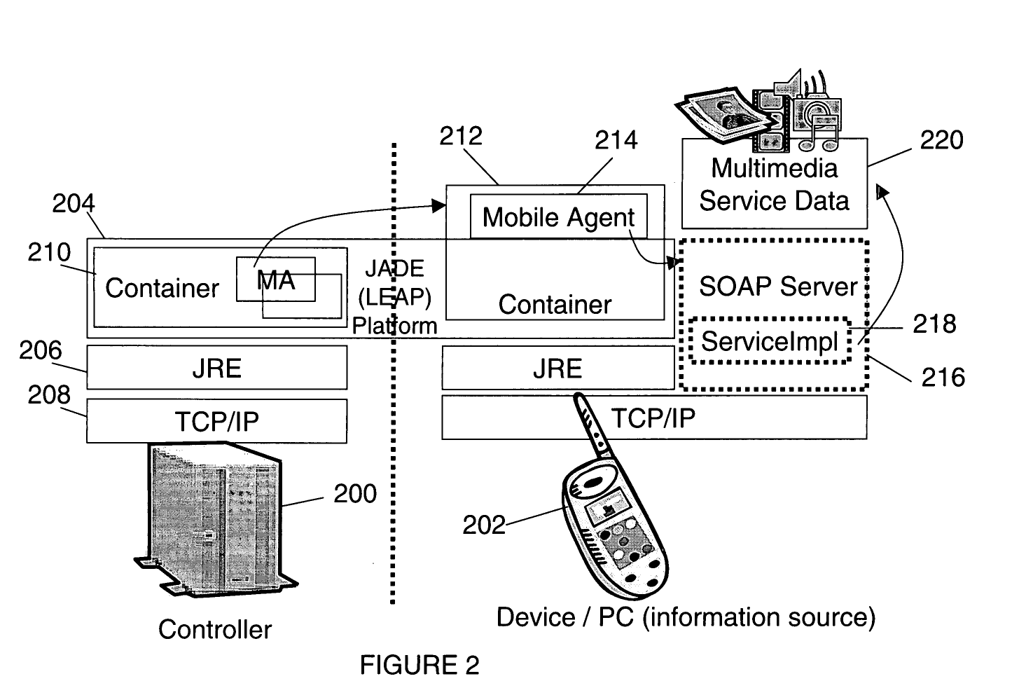

FIG. 2 illustrates an embodiment of the architecture elements, showing a controller 200 and a device/PC 202, such as a cellular phone, constituting an information source on a distributed JADE platform 204 requiring a Java Runtime Environment 206 and TCP/IP stack 208. The JADE platform 204, containers 210, 212 and mobile agent 214 are agent-related, while the SOAP Server 216 service implementation 218 are Web Services related. Once resident on the device, the mobile agent 214 instantiates and controls the lifecycle of a SOAP server 216 and a service implementation (ServiceImpl) 218 which behaves according to the developer's design. Multimedia service data 220 resident on the device 202 (e.g. calendar appointments, photos, etc.) are accessed natively via the ServiceImpl 218.

The Web Services lifecycle is controllable by the mobile agent 214 of the device 202, and, accordingly, by the controller 200 which can send messages to the mobile agent 214. For example, if a user at the controller GUI wishes to immediately tear-down the ‘Microsoft Office Miner’ service on a particular device, the mobile agent resident on the device stops the process implementing the service, stops the process implementing the SOAP server (e.g. tearing down the web service), and cleans up any local libraries or data that may have been useful for the transient service but serves no purpose after the service has terminated. As a result there are two controllable lifecycles: the first is the lifecycle of the Mobile Agent that transports the service, and the second is the lifecycle of the service on the remote device. Once transported and executing, the Controller could choose to terminate either one of these 2 controllable lifecycles independently. The remote lifecycle control could occur from a remote centralized point (e.g. an administrator's PC), or from multiple distributed Controllers.

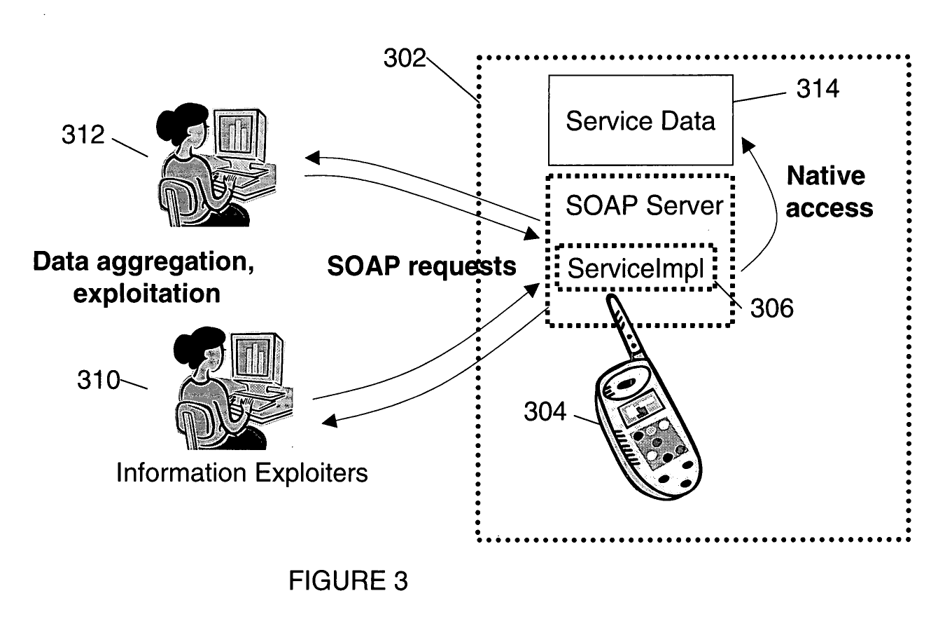

Ad-hoc Service access/exploitation phase as shown in FIG. 3 is possible in two ways. Since the device and controller are ‘federated’ upon a distributed agent platform, an Agent Communication Language (ACL) can be used to directly communicate from the controller to the remote agent. Only administrators can use an ACL. An exploiter is a user or software agent that reads/writes application service data through the Web Service API put in place by the ad-hoc service. Most exploiters, however, will use Web Services to interact with the AHS. Since the mobile agent initiates a SOAP Server 302 onto the device 304 and also brings a Web Service implementation 306, any SOAP client can access the service. SOAP requests are initiated either for information exploitation 310 or data aggregation, exploitation 312 to the SOAP server 302. The SOAP server service 302 accesses service data 314.

Lightweight and agile are two attributes of the AHS framework. Lightweight refers to small-as-feasible memory footprint of software components and agile refers to mobility, life-cycle control, and cross-platform compatibility. In order to accomplish a lightweight and agile AHS framework, different software technologies can be exploited. For example, XSOAP is a lightweight implementation of SOAP for Java and C++. It is a Java RMI implementation that adds SOAP compatibility. It has been tested for compatibility against several Web Services implementations such as Apache. eSOAP is a commercial SOAP server, written in C++, for embedded systems.

XML parsing is an important part of parsing SOAP bodies and message payloads in AHS, particularly since parsing can be very CPU-intensive. Several XML parsers implement the sleek and simple XMLPULL API, and have efficient realizations. MXP1 is one such parser, with a Java.jar file size of less than 20 Kb. MinML is an experimental XML parser designed to run on memory-starved devices and embedded systems; e.g. those that have less than 512 Kb RAM. Implemented in Java, it supports SAX1 document models. The distribution file has a small 14 Kb footprint.

The Java Agent Development Environment (JADE) is one of several mobile agent platforms, but one of the few with support for FIPA standards. JADE allows developers to easily program distributed agent implementations. The Lightweight Extensible Agent Platform (LEAP) is a sophisticated port of JADE to the J2SE, J2ME and PersonalJava. A version of LEAP for PalmPilot, for example, has a reduced heap memory footprint of 86K. While JADE is used in some embodiments of the invention, it will be apparent to those skilled in the art that any similar framework could be used as a mobile agent framework.

Two important Web Services protocols, namely Universal Description, Discovery and Integration (UDDI) and the Web Services Description Language (WSDL), are preferred components of the Web Services.

In UDDI a business entity registers Business Services, each registered business service has a BindingTemplate describing a Web service at a particular address (access point). Good results are achieved when a new use-type value called adHocEndpoint is defined and used to describe AHS services (i.e. it captures better the semantic of ad hoc services)

The Web Services Description Language (WSDL) is a format for describing both the abstract service functionality (i.e. messages sent and received) and the concrete details of the services implementation (e.g. network addresses bindings to transport and wire formats). WSDL feature and property tags are used to express the start-time and end-time directly at the service description level.

W3C Ontology Web Language (OWL) is a sophisticated ontology language, although lesser degrees of sophistication can be achieved through XML Schema and RDF-based ontologies. Modeling multimedia content is important in AHS. For example, characterizing multimedia data and determining which native access methods apply are important considerations. In addition, since exploiters may be software agents, results from queries such as “get all photos stored in the device home directory” must be self-describing and parseable. Accordingly, an embodiment of the present invention exploits OWL and semantic Web technology.

A prototype version of the AHS framework leverages the Sun Java JDK 1.4, JADE 2.6 Agent Environment, and various software toolkits. FIG. 4 illustrates a simple AHS Controller GUI tool 400 which allows administrators to start AHS scenarios. Once the tasks and agents are described in the tool, the agents 402, 404 are launched and begin migrating to remote devices in order to install and manage Web Services to façade device multimedia data. This, in turn, enables the exploitation of any device-resident multimedia information. Note that the mobile agents themselves need not have graphical interfaces.

The AHS agents and service implementations can both be ‘templated’ out. That is, they may be written once and then used multiple times. For example, an AHS that migrates to a remote device, reads all the Internet Favorites from the system, removes those pointing to Yahoo!, and terminates, comprises a class of AHS service. This example of a templated class could be chosen immediately after its implementation, or, at any later time when a Controller wishes to relaunch the AHS, directed at a new set of devices. The destination device addresses are parameterized making the procedure repeatable and scalable.

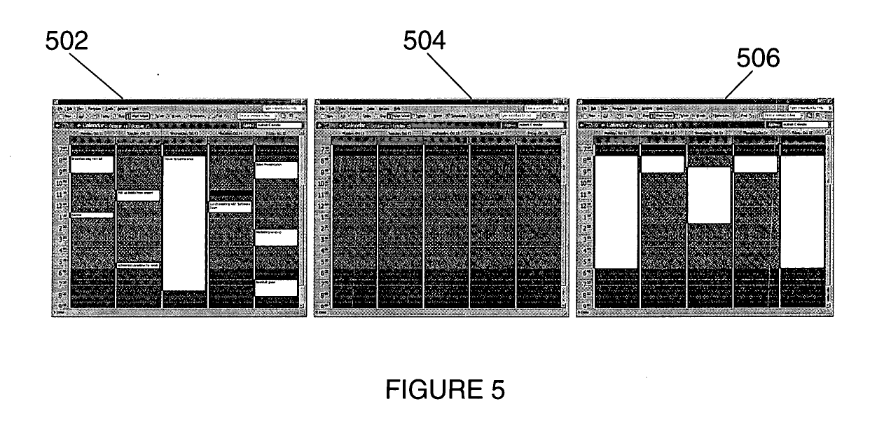

FIG. 5 illustrates some possible effects of having an AHS ad-hoc service running on a user device, such as a PC or a cellular phone. In FIG. 5 the AHS service deployed to the device allows SOAP-based access to Microsoft Outlook multimedia data in the device. The first message sent to the service from the controller, via a SOAP message, backs up the current week appointments 502 in the controller. The next message clears the appointments 504 for the current week. Finally, a next message sends a new set of appointment information to the user. For example, the new appointment information could be the appointment set of another user or a banner message. In FIG. 5 the letter ‘M’ is sent to the Outlook Calendar 506. These, and other types of remote manipulation of service data constitute information exploitation. Afterwards, the AHS restores the original calendar appointments 502. In another setup several computers with 256 Mb RAM, Microsoft Windows 2000, JADE and Java JDK1.4 software are used to test the capabilities of the agent-based AHS in load situations. Using this configuration at a relatively low message-passing request, e.g. 200 req/sec, a single node of the AHS can accommodate 50 or more agents as a function of the cumulative message-passing rate. The result is acceptable because it is Web Services invocations that dominate clients after the deployment and setup phases and it is not expected that lifecycle-type requests will reach 200 req/sec, the rate at which degradation is seen.

AHS is not a Peer-to-Peer system, such as those used for file-sharing, nor is it a Grid Computing platform or single application such as SETI@home (a scientific experiment that uses Internet-connected computers in the Search for Extraterrestrial Intelligence). Rather, AHS provides transient access to multimedia data on devices attached to communications networks (e.g. next-generation networks or Intranets). AHS is much more agile and lightweight than OSGi and component mobility is an integral part of AHS which is not permitted in OSGi. In summary, the Ad-hoc Services framework: exploits inherent advantages of mobile code and information gathering occurs transparently to, but is authorized by, the device owner/user, so the services framework provides a transparent and flexible way to extract service data that is not already shared on servers. As a result enterprises achieve information awareness.

Having described and illustrated a method and system for enabling Web Services to be deployed in an ad-hoc fashion on networked computing devices using taskable mobile agents, it will be apparent to those skilled in the art that variations and modifications are possible without deviating from the broad principles and teachings of the present invention which shall be limited solely by the scope of the claims appended hereto.

What is claimed is:

1. A method for providing transient access to multimedia data on networked computing devices comprising the steps of:
transporting a remotely controllable mobile agent to a computing device in a network;
deploying Web Services to the networked computing device via the mobile agent;
controlling data on the networked computing device according to the Web Services as controlled by the mobile agent, and
controlling the lifecycle of the Web Services by the mobile agent.

2. A method for providing transient access to multimedia data on networked computing devices as set forth in claim 1, wherein said remotely controllable mobile agent is lightweight.

3. A method for providing transient access to multimedia data on networked computing devices as set forth in claim 1, wherein said remotely controllable mobile agent is agile.

4. A method for providing transient access to multimedia data on networked computing devices as set forth in claim 1, wherein said remotely controllable mobile agent controls the life cycle of a Web Service

5. A method for providing transient access to multimedia data on networked computing devices as set forth in claim 1, wherein said remotely controllable mobile agent comprises software selected from the group consisting of: Apache SOAP server, XSOAP server, eSOAP server, XML parser, XMLPULL parser, and MinML parser.

6. A method for providing transient access to multimedia data on networked computing devices as set forth in claim 1, wherein said remotely controllable mobile agent encapsulates and controls a SOAP server.

7. A method for providing transient access to multimedia data on networked computing devices as set forth in claim 1, wherein said remotely controllable mobile agent comprises OWL software.

8. A method for providing transient access to multimedia data on networked computing devices as set forth in claim 1, wherein said remotely controllable mobile agent is supported by a mobile agent framework.

9. A method for providing transient access to multimedia data on networked computing devices as set forth in claim 1, wherein said remotely controllable mobile agent platform comprises Java Agent Development Environment (JADE) software.

10. A method for providing transient access to multimedia data on networked computing devices as set forth in claim 1, wherein the Web Services deployed via the mobile agent onto the networked computing devices are described in a Web Services registry.

11. A method for providing transient access to multimedia data on networked computing devices as set forth in claim 10, wherein the registry is Universal Description, Discovery and Integration (UDDI).

12. A method for providing transient access to multimedia data on networked computing devices as set forth in claim 10, wherein the registry distinguishes the Web Services from permanent services through registry meta-data.

13. A method for providing transient access to multimedia data on networked computing devices as set forth in claim 1, wherein the Ad-Hoc Services expose an interface that is described using the Web Services Description Language (WSDL).

14. A method for providing transient access to multimedia data on networked computing devices as set forth in claim 1, wherein said Web Services and the mobile agents which transport them have realizations as Java classes.

15. A system for providing transient access to multimedia data on networked computing devices comprising:
remotely controllable mobile agent transported to a computing device in a network;
Web Services deployed to said computing device via said remotely controllable mobile agent, said Web Services controlling data in said computing device according to said mobile agent;
said mobile agent controlling the life cycle of the Web Services.

16. A system for providing transient access to multimedia data on networked computing devices as set forth in claim 15, wherein said remotely controllable mobile agent is lightweight.

17. A system for providing transient access to multimedia data on networked computing devices as set forth in claim 15, wherein said remotely controllable mobile agent is agile.

18. A system for providing transient access to multimedia data on networked computing devices as set forth in claim 15, wherein said remotely controllable mobile agent controls the life cycle of a Web Service

19. A system for providing transient access to multimedia data on networked computing devices as set forth in claim 15, wherein said remotely controllable mobile agent comprises software selected from the group consisting of: Apache SOAP server, XSOAP server, eSOAP server, XML parser, XMLPULL parser, and MinML parser.

20. A system for providing transient access to multimedia data on networked computing devices as set forth in claim 15, wherein said remotely controllable mobile agent comprises SOAP software.

21. A system for providing transient access to multimedia data on networked computing devices as set forth in claim 15, wherein said remotely controllable mobile agent comprises OWL software.

22. A system for providing transient access to multimedia data on networked computing devices as set forth in claim 13, wherein said remotely controllable mobile agent is supported by a mobile agent framework.

23. A system for providing transient access to multimedia data on networked computing devices as set forth in claim 15, wherein said remotely controllable mobile agent platform comprises Java Agent Development Environment (JADE) software.

24. A system for providing transient access to multimedia data on networked computing devices as set forth in claim 15, wherein the Web Services deployed via the mobile agent onto the networked computing devices are described in a Web Services registry.

25. A method for providing transient access to multimedia data on networked computing devices as set forth in claim 24, wherein the registry is Universal Description, Discovery and Integration (UDDI).

26. A method for providing transient access to multimedia data on networked computing devices as set forth in claim 24, wherein the registry distinguishes the Web Services from permanent services through registry meta-data.

27. A system for providing transient access to multimedia data on networked computing devices as set forth in claim 15, wherein said Web Services protocol is Web Services Description Language (WSDL).

28. A system for providing transient access to multimedia data on networked computing devices as set forth in claim 15, wherein said Web Services is a Java class.

29. A system for providing transient access to multimedia data on networked computing devices as set forth in claim 15, further comprising controller for sending instructions to said remotely controllable mobile agent.

30. A system for providing transient access to multimedia data on networked computing devices as set forth in claim 15, further comprising controller for sending instructions to said remotely controllable mobile agent for undeploying the Web Services.
